(19) United States
(12) Patent Application Publication
(10) Pub. No.: US 2026/0016639 A1
(43) Pub. Date: Jan. 15, 2026

(54) SYMMETRICAL PUPIL EXPANSION APPARATUS AND NEAR-EYE DISPLAY DEVICE

(71) Applicant: LINGXI-AR Technology Co., Ltd., Beijing (CN)

(72) Inventors: Zhiyuan GU, Beijing (CN); Yu ZHENG, Beijing (CN)

(21) Appl. No.: 19/264,066

(22) Filed: Jul. 9, 2025

(30) Foreign Application Priority Data
Jul. 12, 2024 (CN) 202410940284.6

(51) Int. Cl. G02B 6/34; G02B 27/01

(52) U.S. Cl. CPC G02B 6/34; G02B 27/0172; G02B 2027/0123

(57) ABSTRACT

Provided are a near-eye display device and a symmetrical pupil expansion apparatus including: a first waveguide sheet and a second waveguide sheet are parallel to each other and are stacked, and a first turning mirror and a second turning mirror are arranged correspondingly; a first waveguide structure is mirror-symmetrical to a second waveguide structure, a turning reflection slope of the first turning mirror is parallel to first beam splitters; a turning reflection slope of the second turning mirror is parallel to second beam splitters; a cementing layer is disposed between two waveguide sheets; a geometric in-coupling prism is disposed in a middle region between turning structures, the projected surface of the geometric in-coupling prism facing the second direction is a quadrilateral including a light incident edge and a light emission edge opposite to each other, and a first side edge and a second side edge opposite to each other.

### CROSS-REFERENCE TO RELATED APPLICATION(S)

This application claims priority to Chinese Patent Application No. 202410940284.6, filed on Jul. 12, 2024, the disclosure of which is incorporated herein by reference in its entirety.

### TECHNICAL FIELD

The present disclosure relates to the technical field of augmented reality and, in particular, to a symmetrical pupil expansion apparatus and a near-eye display device.

### BACKGROUND

Augmented reality (AR) is a technology that cleverly integrates virtual information with the real world. Augmented reality can simulate computer-generated virtual information, such as text, images, three-dimensional models, music, and videos, and apply the computer-generated virtual information to the real world to supplement real information in the real world and “augment” the real world. Head-mounted displays using augmented reality can allow virtual images to be projected into people's eyes while the people examine the surrounding environments, which are of great significance in the fields of military, industry, entertainment, medical care, transportation, and others.

Main techniques currently used in transmissive head-mounted displays for augmented reality include Birdbath, a prism, a free-form surface, and an optical waveguide technique. Compared with other techniques, a head-mounted display using the optical waveguide technique is smaller in size and more like a pair of glasses. The optical waveguide technique mainly includes an arrayed optical waveguide, a surface relief grating waveguide, and a volumetric holographic waveguide. The array optical waveguide is superior to a diffraction optical waveguide and the volumetric holographic waveguide in color performance and luminous energy utilization. In particular, the array optical waveguide using a two-dimensional exit pupil expansion technique has the advantages of a small in-coupling optical machine volume, a large exit pupil distance, and a large eye box.

As people's requirements for immersive experience and the appearance of AR glasses become increasingly higher, technicians are also required to enable the shape and volume of a display system to be similar to those of ordinary glasses while needing to increase the angle of view of the display system. Due to the asymmetry of an existing two-dimensional array waveguide technique, if a common material having a low refractive index (such as H-BAK5, n=1.56) is used, the angle of view of a product with a reasonable morphological design does not exceed 50°; if a material having a high refractive index is used, the processing difficulty and cost of a two-dimensional waveguide plate are greatly increased, and the asymmetry of the structure cannot be changed. When a larger field of view is transmitted, the problem of increased volume is brought by. In addition to this, since a turning structure in a conventional two-dimensional arrayed waveguide does not display an image, the center of an effective display region is located in the middle and lower region of the entire waveguide, which deviates greatly from the optimal position of the human eye.

### SUMMARY

According to the problems existing in the related art, the present disclosure provides a symmetrical pupil expansion apparatus and a near-eye display device.

The technical solutions of the present disclosure are described below.

The present disclosure provides a symmetrical pupil expansion apparatus. The symmetrical pupil expansion apparatus includes a first waveguide sheet, a second waveguide sheet, a cementing layer, and a geometric in-coupling prism.

The first waveguide sheet includes a first waveguide structure and a first out-coupling structure that are sequentially arranged along a first direction, where the first waveguide structure includes a first turning mirror and a first turning structure that are sequentially arranged along a second direction, where the first turning structure includes multiple first beam splitters parallel to each other.

The second waveguide sheet includes a second waveguide structure and a second out-coupling structure that are sequentially arranged along the first direction, where the second waveguide structure includes a second turning mirror and a second turning structure that are sequentially arranged along a third direction, where the second turning structure includes multiple second beam splitters parallel to each other.

The second waveguide sheet and the first waveguide sheet are parallel to each other and are stacked, the first turning mirror and the second turning mirror, the first waveguide structure is mirror-symmetrical to the second waveguide structure, and a turning reflection slope of the first turning mirror is parallel to the multiple first beam splitters; a turning reflection slope of the second turning mirror is parallel to the multiple second beam splitters; the second direction is parallel to the third direction and opposite to the third direction, and the first direction is perpendicular to the second direction and/or the third direction.

The cementing layer is disposed between the first waveguide sheet and the second waveguide sheet.

The geometric in-coupling prism is disposed in a middle region between the first turning structure and the second turning structure, where a projected surface of the geometric in-coupling prism facing the second direction is a quadrilateral, where the quadrilateral includes a light incident edge and a light emission edge that are opposite to each other, and a first side edge and a second side edge that are opposite to each other, where the light incident edge and the first side edge form an acute angle θ, the acute angle θ=60° to 80°, and the first side edge is perpendicular to the light emission edge.

As a preferred technical solution, a thickness of the first waveguide sheet is the same as or different from a thickness of the second waveguide sheet.

As a preferred technical solution, the second side edge and the light incident edge form a first included angle, the second side edge and the light emission edge form a second included angle, and the first included angle is the same as or different from the second included angle.

As a preferred technical solution, the multiple first beam splitters are arranged equidistantly and form an inclination angle a with the second direction, where the inclination angle α=40° to 50°; the multiple second beam splitters are arranged equidistantly and form an inclination angle β with the third direction, where the inclination angle a and the inclination angle β have a same degree and opposite directions.

As a preferred technical solution, the first out-coupling structure includes multiple third beam splitters arranged equidistantly along the first direction, and the second out-coupling structure includes multiple fourth beam splitters arranged equidistantly along the first direction, where the first out-coupling structure and the second out-coupling structure are arranged correspondingly, and a number of third beam splitters is the same as a number of fourth beam splitters.

As a preferred technical solution, the geometric in-coupling prism is a quadrangular prism, and the first turning mirror and the second turning mirror are triangular prisms or quadrangular prisms.

As a preferred technical solution, the first waveguide structure further includes a first compensation plate, and the second waveguide structure further includes a second compensation plate; the first compensation plate and the second turning structure are arranged correspondingly, and the second compensation plate and the first turning structure are arranged correspondingly.

As a preferred technical solution, the cementing layer is disposed between the first waveguide sheet and the second waveguide sheet, and the following first formula is satisfied:

$$sin ( 2 ω - \frac{μ}{2} ) \geq \frac{{n}_{G}}{{n}_{W}}$$

where the multiple third beam splitters and the multiple fourth beam splitters each form an angle ω with the first direction; 0°≤μ≤40°; a refractive index of the first waveguide sheet and a refractive index of the second waveguide sheet are n_{W}; a refractive index of the cementing layer is n_{G}; a thickness of the cementing layer is from 0.5 μm to 5 μm.

As a preferred technical solution, the cementing layer is disposed between the first waveguide sheet and the second waveguide sheet, a magnesium fluoride coating is provided between the first waveguide sheet and the cementing layer and between the second waveguide sheet and the cementing layer, and the following second formula is satisfied:

$$sin ( 2 ω - \frac{μ}{2} ) \geq \frac{{n}_{C}}{{n}_{W}}$$

where the multiple third beam splitters and the multiple fourth beam splitters each form an angle ω with the first direction; 0°≤μ≤40°; a refractive index of the first waveguide sheet and a refractive index of the second waveguide sheet are n_{W}; a refractive index of the magnesium fluoride coating is n_{C}; a thickness of the cementing layer is from 0.5 μm to 5 μm; a thickness of the magnesium fluoride coating is from 80 nm to 500 nm.

The present disclosure further provides a near-eye display device including the preceding symmetrical pupil expansion apparatus.

The technical solutions used in the present disclosure achieve the beneficial effects below.

The present disclosure provides the symmetrical pupil expansion apparatus. The symmetrical pupil expansion apparatus includes the first waveguide sheet and the second waveguide sheet that are mirror-symmetrical, and the geometric in-coupling prism. Compared with a conventional waveguide solution, the shape and structure have mirror symmetry. Light passes through the geometric in-coupling prism to evenly divide energy into the first waveguide sheet and the second waveguide sheet, so luminous energy is symmetrical, and angles of view output by the first waveguide sheet and the second waveguide sheet are also symmetrical. This apparatus can achieve a large angle of view effectively and have high luminous energy utilization. Most importantly, the entire field of view can be displayed as long as the heights of the turning structures in the first waveguide sheet and the second waveguide sheet satisfy the transmission of half of the field of view, which helps to reduce the processing difficulty and reduce the volume of a two-dimensional arrayed waveguide.

### BRIEF DESCRIPTION OF DRAWINGS

To describe the technical solutions of embodiments of the present disclosure more clearly, drawings used in the description of the embodiments are briefly described below and form a part of the present disclosure. The example embodiments and descriptions thereof in the present disclosure explain the present disclosure and do not limit the present disclosure in any improper way.

FIG. 1 is a schematic diagram of a symmetrical pupil expansion apparatus according to this embodiment.

FIG. 2 is a schematic diagram of a symmetrical pupil expansion apparatus according to this embodiment.

FIG. 3 is a side diagram of a symmetrical pupil expansion apparatus according to this embodiment.

FIG. 4 is a schematic diagram of a symmetrical pupil expansion apparatus according to this embodiment.

Reference list

| | |
|---|---|
| 100 | first waveguide sheet |
| 101 | first turning structure |
| 102 | first out-coupling structure |
| 103 | first turning mirror |
| 104 | first compensation plate |
| 200 | second waveguide sheet |
| 201 | second turning structure |
| 202 | second out-coupling structure |
| 203 | second turning mirror |
| 204 | second compensation plate |
| 300 | geometric in-coupling prism |
| 301 | cementing layer |
| 400 | composite waveguide sheet |

### DETAILED DESCRIPTION

To illustrate the object, technical solutions, and advantages of the present disclosure more clearly, the technical solutions of the present disclosure are described clearly and completely in conjunction with the embodiments of the present disclosure and the drawings.

In the description of the present disclosure, it is to be noted that the term “or” is generally used in a meaning including “and/or” unless the content clearly indicates otherwise.

In the description of the present disclosure, it is to be understood that terms “first” and “second” are only configured to distinguish the description, and are not to be construed as indicating or implying relative importance. In the description of the present disclosure, it is to be noted that unless otherwise expressly specified and limited, the term “connected to each other” or “connected” should be construed in a broad sense, for example, as securely connected, detachably connected, or integrally connected; mechanically connected or electrically connected; directly connected to each other or indirectly connected to each other via an intermediary. For those of ordinary skill in the art, specific meanings of the preceding terms in the present disclosure may be understood based on specific situations.

In addition, it is to be understood by those skilled in the art that in the description of the present disclosure, orientations or positional relationships indicated by terms “longitudinal”, “transverse”, “above”, “below”, “front”, “back”, “left”, “right”, “vertical”, “horizontal”, “top”, “bottom”, “inside”, “outside” and the like are based on the drawings. These orientations or positional relationships are only intended to facilitate and simplify the description of the present disclosure. These orientations or positional relationships do not indicate or imply that an apparatus or element referred to must have such particular orientations and must be constructed and operated in such particular orientations. Thus, the preceding terms are not to be construed as limiting the present disclosure.

Apparently, the described embodiments are part, not all, of embodiments of the present disclosure. Based on the embodiments of the present disclosure, all other embodiments obtained by those of ordinary skill in the art without creative work are within the scope of the present disclosure.

### EMBODIMENT

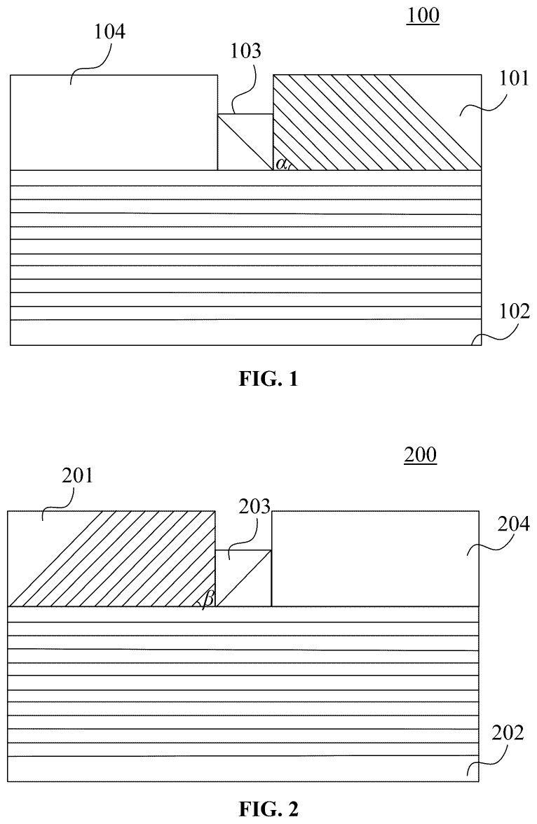

According to FIGS. 1 to 4, this embodiment provides a symmetrical pupil expansion apparatus. The symmetrical pupil expansion apparatus includes a first waveguide sheet 100, a second waveguide sheet 200, a cementing layer 301, and a geometric in-coupling prism 300.

The first waveguide sheet 100 includes a first waveguide structure and a first out-coupling structure 102 that are sequentially arranged along the first direction, the first waveguide structure includes a first turning mirror and a first turning structure 101 that are sequentially arranged along the second direction, and the first turning structure 101 includes multiple first beam splitters parallel to each other.

The second waveguide sheet 200 includes a second waveguide structure and a second out-coupling structure 202 that are sequentially arranged along the first direction, the second waveguide structure includes a second turning mirror 203 and a second turning structure 201 that are sequentially arranged along the third direction, and the second turning structure 201 includes multiple second beam splitters parallel to each other.

The second waveguide sheet 200 and the first waveguide sheet 100 are parallel to each other and are stacked, the first turning mirror and the second turning mirror 203 are arranged correspondingly, the first waveguide structure is mirror-symmetrical to the second waveguide structure, and a turning reflection slope of the first turning mirror 103 is parallel to the multiple first beam splitters; a turning reflection slope of the second turning mirror 203 is parallel to the multiple second beam splitters; the second direction is parallel to the third direction and opposite to the third direction, and the first direction is perpendicular to the second direction and/or the third direction.

The cementing layer 301 is disposed between the first waveguide sheet 100 and the second waveguide sheet 200.

The geometric in-coupling prism 300 is disposed in a middle region between the first turning structure 101 and the second turning structure 201, the projected surface of the geometric in-coupling prism 300 facing the second direction is a quadrilateral, the quadrilateral includes a light incident edge and a light emission edge that are opposite to each other, and a first side edge and a second side edge that are opposite to each other, the light incident edge and the first side edge form an acute angle θ, the acute angle θ=60° to 80°, and the first side edge is perpendicular to the light emission edge.

Based on the asymmetrical structural characteristics of an existing single-layer two-dimensional arrayed waveguide and the limited angle of view, this embodiment provides the symmetrical pupil expansion apparatus. The symmetrical pupil expansion apparatus includes the first waveguide sheet 100 and the second waveguide sheet 200 that are mirror-symmetrical, and the geometric in-coupling prism 300. Compared with a conventional waveguide solution, the shape and structure have mirror symmetry. Light passes through the geometric in-coupling prism 300 to evenly divide energy into the first waveguide sheet 100 and the second waveguide sheet 200, so luminous energy is symmetrical, and angles of view output by the first waveguide sheet 100 and the second waveguide sheet 200 are also symmetrical. This apparatus can achieve a large angle of view effectively and have high luminous energy utilization. Most importantly, the entire field of view can be displayed as long as the heights of the turning structures in the first waveguide sheet 100 and the second waveguide sheet 200 satisfy the transmission of half of the field of view, which helps reduce the processing difficulty and reduce the volume of the two-dimensional arrayed waveguide.

Preferably, the thickness of the first waveguide sheet 100 is the same as or different from the thickness of the second waveguide sheet 200.

Preferably, the second side edge and the light incident edge form a first included angle, the second side edge and the light emission edge form a second included angle, and the first included angle is the same as or different from the second included angle.

Specifically, as shown in FIGS. 1 to 4, the first waveguide sheet 100 includes the first waveguide structure and the first out-coupling structure 102 that are sequentially arranged along the first direction, and the first waveguide structure includes the first turning mirror 103 and the first turning structure 101 that are sequentially arranged along the second direction; the second waveguide sheet 200 includes the second waveguide structure and the second out-coupling structure 202 that are sequentially arranged along the first direction, and the second waveguide structure includes the second turning mirror 203 and the second turning structure 201 that are sequentially arranged along the third direction. In short, the first waveguide sheet 100 and the second waveguide sheet 200 are two two-dimensional arrayed waveguide sheets that are mirror-symmetrical. Preferably, the first waveguide sheet 100 and the second waveguide sheet 200 have the same size, where the number of first beam splitters is the same as the number of second beam splitters, preferably the number is 5 to 8. The process is simple and easy to operate, and a cemented waveguide has strong symmetry in structure and optical effect. It is to be noted that the first beam splitters and the second beam splitters that are shown in the drawings are schematic and do not limit the embodiment of the present disclosure. The number of beam splitters may be designed according to actual situations during specific implementation.

As shown in FIG. 4, the first waveguide sheet 100 and the second waveguide sheet 200 are stacked and cemented to form a composite waveguide sheet 400. From the overall point of view, the first out-coupling structure 102 and the second out-coupling structure 202 are arranged correspondingly, the first turning structure 101 is mirror-symmetrical to the second turning structure 201, and the turning reflection slope of the first turning mirror 103 and the turning reflection slope of the second turning mirror 203 intersect.

Using the second waveguide sheet 200 located in front of the first waveguide sheet 100 as an example, the geometric in-coupling prism 300 is disposed in the middle region between the first turning structure and the second turning structure 201, preferably a quadrangular prism. The projection of the geometric in-coupling prism 300 in the second direction is a quadrilateral, the quadrilateral includes the light incident edge and the light emission edge that are opposite to each other, and the first side edge and the second side edge that are opposite to each other, the light incident edge is arranged at the acute angle θ with the first side edge, and the acute angle θ=60° to 80°.

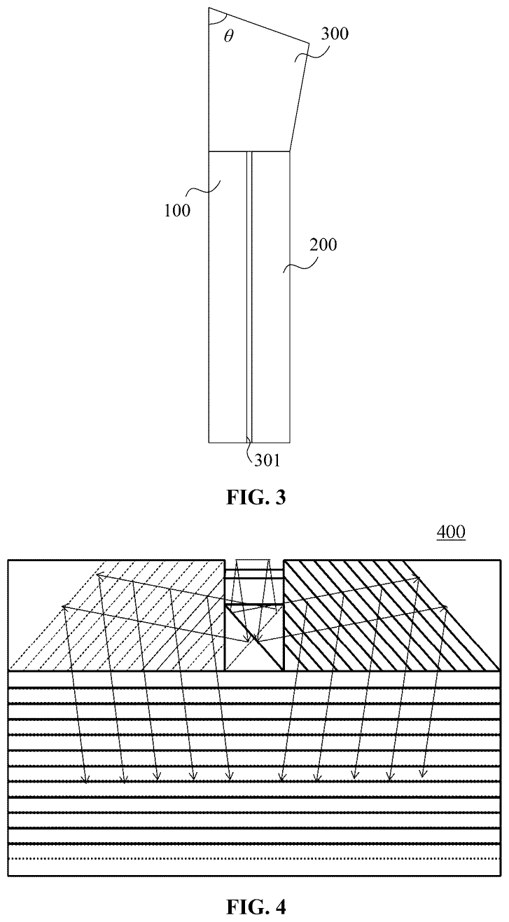

Further, as shown in FIG. 3, from the projection in the second direction, the first side edge and a substrate outside the first waveguide sheet 100 are parallel and located on the same straight line, and the first side edge is perpendicular to the light emission edge. In this embodiment, the first included angle between the light incident edge and the second side edge and the second included angle between the light emission edge and the second side edge are preferably both obtuse angles, and the specific degrees are set by those skilled in the art according to the requirements of the structure. Preferably, the acute angle θ of the geometric in-coupling prism 300 is equal to 70°. The degree of the first included angle is different from the degree of the second included angle. The composite waveguide sheet 400 has strong symmetry and can easily transmit and display an image with a large angle of view in combination with the large-angle geometric in-coupling prism 300.

This arrangement helps an optical machine to emit a parallel light beam carrying virtual image information. The parallel light beam is incident perpendicularly on the geometric in-coupling prism 300 through the light incident surface. Half of light is redirected by a first turning prism to be incident on the first waveguide sheet 100, that is, a first beam of light, and the other half of the light is redirected by a second turning prism to be incident on the second waveguide sheet 200, that is, a second beam of light. In other words, energy of the incident beam of light is equal to the sum of energy of the first beam of light and energy of the second beam of light, and the energy of the first beam of light is equal to the energy of the second beam of light, without luminous energy loss. Moreover, there is no loss in brightness uniformity, and the luminous energy utilization is higher. FIG. 4 shows a propagation schematic diagram of evenly dividing the beam of light into the first beam of light and the second beam of light. To clearly describe the light beam propagation, arrows are used in FIG. 4 to schematically illustrate the general trend of the light, and a specific situation depends on the actual situation.

Since the first beam of light is incident on the first waveguide sheet 100 for total reflection transmission and is coupled out to the human eye, a first angle of view is provided; the second beam of light is incident on the second waveguide sheet 200 for total reflection transmission and is coupled out to the human eye, the second angle of view is provided; the first beam of light and the second beam of light are mirror-symmetrical and have the same luminous energy. In a preferred embodiment, the energy ratio of image light of the first waveguide sheet 100 and image light of the second waveguide sheet 200 can also be adjusted by setting the thickness ratio of the first waveguide sheet 100 to the second waveguide sheet 200 so that the brightness uniformity of a first field of view and a second field of view can be well adjusted.

Preferably, the multiple first beam splitters are arranged equidistantly and form an inclination angle a with the second direction, where the inclination angle α=40° to 50°; the multiple second beam splitters are arranged equidistantly and form an inclination angle β with the third direction, where the inclination angle a and the inclination angle β have the same degree and opposite directions.

Preferably, the first out-coupling structure 102 includes multiple third beam splitters arranged equidistantly along the first direction, and the multiple third beam splitters are parallel to the second direction and/or the third direction; the second out-coupling structure 202 includes multiple fourth beam splitters arranged equidistantly along the first direction, and the multiple fourth beam splitters are parallel to the second direction and/or the third direction; the first out-coupling structure 102 and the second out-coupling structure 202 are arranged correspondingly, and the number of third beam splitters is the same as the number of fourth beam splitters.

Specifically, the first waveguide sheet 100 and the second waveguide sheet 200 are both two-dimensional arrayed waveguide structures, that is, each includes a turning structure and an out-coupling structure. The first turning structure 101 and the first out-coupling structure 102 in the first waveguide sheet 100 specifically include that the multiple first beam splitters each have the inclination angle a and are arranged equidistantly along the second direction, so as to expand the pupil of the first beam of light along the second direction and change the transmission direction of the first beam of light so that the reflected first beam of light is transmitted in the direction of the first out-coupling structure 102; the multiple third beam splitters are arranged equidistantly along the first direction and are parallel to the second direction and/or the third direction, so as to re-expand, in the first direction, the pupil of the first beam of light output from the first turning structure 101 after the pupil expansion, and project a coupled-out waveguide to the human eye at the exit pupil position for imaging.

The second turning structure 201 and the second out-coupling structure 202 in the second waveguide sheet 200 specifically include that the multiple second beam splitters each have the inclination angle β and are arranged equidistantly along the third direction, so as to expand the pupil of the second beam of light along the third direction; the multiple fourth beam splitters are arranged equidistantly along the first direction and are parallel to the second direction and/or the third direction, so as to re-expand, in the first direction, the pupil of the second beam of light output from the second turning structure 201 after the pupil expansion. Preferably, α=β=45°, and the cemented waveguide has stronger structural symmetry, stronger luminous energy equalization, stronger light symmetry, and stronger symmetry of angles of field of view.

Finally, the first beam of light output by the first out-coupling structure 102 after the pupil expansion forms the first angle of view, the second beam of light output by the second out-coupling structure 202 after the pupil expansion forms the second angle of view, and the first angle of view and the second angle of view are symmetrical. During observation, the human eye both receives the image light from the first waveguide sheet 100 and the image light from the second waveguide sheet 200, and two half field of view images are spliced into a complete field of view image.

Compared with a conventional two-dimensional waveguide sheet, the height of a turning structure of the waveguide sheet needs to satisfy the transmission of the entire field of view in order to display a complete image. As shown in FIG. 4, in this embodiment, the heights of the turning structures of the first waveguide sheet 100 and the second waveguide sheet 200, that is, the heights along the first direction, only need to satisfy the transmission of half of the field of view to display the entire field of view, effectively achieving a large angle of view, which can greatly reduce the volume of the two-dimensional arrayed waveguide and reduce the actual processing difficulty.

It is to be noted that the third beam splitters and the fourth beam splitters that are shown in the drawings are schematic and do not limit the embodiment of the present disclosure. The number of beam splitters may be designed according to actual situations during specific implementation.

Preferably, the first turning mirror 103 and the second turning mirror 203 are triangular prisms or quadrangular prisms.

Specifically, the first turning mirror 103 and the second turning mirror 203 are preferably triangular prisms or quadrangular prisms. Using the triangular prisms as an example, the first turning mirror 103 and the second turning mirror 203 are preferably regular triangular prisms. Slopes of the regular triangular prisms are turning reflection surfaces. The projections of the first turning mirror 103 and the second turning mirror 203 along the fourth direction are each a right triangle. The right triangle projected by the first turning mirror 103 includes two first right-angled sides and a first hypotenuse, and the right triangle projected by the second turning mirror 203 includes two second right-angled sides and a second hypotenuse. The first hypotenuse is parallel to the first beam splitters, and the second hypotenuse is parallel to the second beam splitters, that is, the first hypotenuse intersects the second hypotenuse, and the included angle between the first hypotenuse and the second direction is α, and preferably α=45°; the included angle between the second hypotenuse and the third direction is β, and preferably β=45°. If the first turning mirror 103 and the second turning mirror both use quadrangular prisms, it is equivalent to a quadrangular prism formed by splicing the preceding two regular triangular prisms, and the splicing position is the turning reflection surface. The use of quadrangular prisms has better stability.

The placement positions of the first turning mirror 103 and the second turning mirror 203 may refer to the placement positions shown in FIGS. 1 and 2. When a beam of parallel light emitted by the optical machine is coupled in through the geometric in-coupling prism 300, half of the light is redirected by the first turning prism to be incident on the first waveguide sheet 100, and the other half of the light is redirected by the second turning prism to be incident on the second waveguide sheet 200. The fourth direction is perpendicular to the first direction, the second direction, and the third direction.

Preferably, the first waveguide structure further includes a first compensation plate 104, and the second waveguide structure further includes a second compensation plate 204; the first compensation plate 104 and the second turning structure 201 are arranged correspondingly, and the second compensation plate 204 and the first turning structure 101 are arranged correspondingly.

Specifically, the first waveguide structure further includes the first compensation plate 104 which is arranged adjacent to the first turning prism; the second waveguide structure further includes the second compensation plate 204 which is arranged adjacent to the second turning prism. After the first waveguide sheet 100 and the second waveguide sheet 200 are cemented together, the first compensation plate 104 and the second turning structure 201 are arranged correspondingly, and the second compensation plate 204 and the first turning structure 101 are arranged correspondingly, which enables the overall waveguide structure to be more stable and have a more balanced support force.

In this embodiment, the geometric in-coupling prism 300, the first turning mirror 103, the second turning mirror 203, the first compensation plate 104, and the second compensation plate 204 are preferably made of glass; in this embodiment, a waveguide substrate, the geometric in-coupling prism 300, the first turning mirror 103, the second turning mirror 203, the first compensation plate 104, and the second compensation plate 204 are made of the same material. The same material makes the optical properties of the waveguide substrate and the prisms the same, ensuring that the light can propagate in a straight line in an optical waveguide assembly and thereby ensuring the imaging quality.

Preferably, the cementing layer 301 is disposed between the first waveguide sheet 100 and the second waveguide sheet 200, and the following first formula is satisfied:

$$sin ( 2 ω - \frac{μ}{2} ) \geq \frac{{n}_{G}}{{n}_{W}}$$

The multiple third beam splitters and the multiple fourth beam splitters each form an angle ω with the first direction; 0°≤μ≤40°; the refractive index of the first waveguide sheet 100 and the refractive index of the second waveguide sheet 200 are n_{W}; the refractive index of the cementing layer 301 is n_{G}.

Preferably, the cementing layer 301 is disposed between the first waveguide sheet 100 and the second waveguide sheet 200, a magnesium fluoride coating is provided between the first waveguide sheet 100 and the cementing layer 301 and between the second waveguide sheet 200 and the cementing layer 301, and the following second formula is satisfied:

$$sin ( 2 ω - \frac{μ}{2} ) \geq \frac{{n}_{C}}{{n}_{W}}$$

The multiple third beam splitters and the multiple fourth beam splitters each form an angle ω with the first direction; 0°≤μ≤40°; the refractive index of the first waveguide sheet 100 and the refractive index of the second waveguide sheet 200 are n_{W}; the refractive index of the magnesium fluoride coating is n_{C}.

Specifically, sealing between the first waveguide sheet 100 and the second waveguide sheet 200 needs to be strict without any gap, that is, no air can be involved, so as to ensure that light is stably transmitted in the composite waveguide sheet 400 with no luminous energy loss. In this embodiment, the cementing layer 301 is preferably adopted, and there are two specific structures. One is that the cementing layer 301 is located between the first waveguide sheet 100 and the second waveguide sheet 200, which satisfies the following first relationship formula:

$$sin ( 2 ω - \frac{μ}{2} ) \geq \frac{{n}_{G}}{{n}_{W}}$$

The other one is that the cementing layer 301 is located between the first waveguide sheet 100 and the second waveguide sheet 200 and that the magnesium fluoride coating is provided between the first waveguide sheet 100 and the cementing layer 301 and between the second waveguide sheet 200 and the cementing layer 301, which satisfies the following second relationship formula:

$$sin ( 2 ω - \frac{μ}{2} ) = \frac{{n}_{C}}{{n}_{W}}$$

Preferably, the thickness of the preceding cementing layer 301 is from 0.5 μm to 5 μm so that the first waveguide structure and the second waveguide structure, as well as the first out-coupling structure 102 and the second out-coupling structure 202 can be tightly secured and cemented together, and the structural strength is large. The cementing layer 301 may be optical cement or another transparent colloid that satisfies the first relationship formula and the second relationship formula, which is not specifically limited here.

Preferably, the thickness of the magnesium fluoride coating is from 80 nm to 500 nm. In actual operation, the magnesium fluoride coating may be uniformly applied to the to-be-cemented surfaces of the first waveguide sheet 100 and the second waveguide sheet, then the cementing layer 301 is applied to the first waveguide sheet 100 whose surface is applied with the magnesium fluoride coating or the second waveguide sheet whose surface is applied with the magnesium fluoride coating, and finally the second waveguide sheet whose surface is applied with the magnesium fluoride coating or the first waveguide sheet 100 whose surface is applied with the magnesium fluoride coating is cemented. The specific process is set according to actual requirements and is not specifically limited herein. The design of the magnesium fluoride coating avoids confusion in light transmission, ensures stable total reflection transmission of the light within the first waveguide sheet 100 or the second waveguide sheet 200, and improves the stability of a displayed image. The magnesium fluoride coating may also be replaced by other transparent coatings with good compactness and other good optical properties, as long as the second relationship formula is satisfied.

This embodiment further provides a near-eye display device including the preceding symmetrical pupil expansion apparatus, which has strong symmetry. The entire field of view can be displayed as long as the heights of the turning structures satisfy the transmission of half of the field of view. In this manner, luminous energy utilization can be high, the volume can be small, and the process difficulty can be reduced.

The preceding describes the symmetrical pupil expansion apparatus and the near-eye display device in detail. The principles and implementations of the present disclosure are described herein with specific examples. The preceding description of the embodiments is only for assisting in understanding the method of the present disclosure and the core ideas thereof. Moreover, for those of ordinary skill in the art, according to the idea of the present disclosure, there will be changes in specific implementations and applications. In summary, the content of this specification should not be construed as limiting the present disclosure.

What is claimed is:

1. A symmetrical pupil expansion apparatus, comprising:
a first waveguide sheet comprising a first waveguide structure and a first out-coupling structure that are sequentially arranged along a first direction, wherein the first waveguide structure comprises a first turning mirror and a first turning structure that are sequentially arranged along a second direction, wherein the first turning structure comprises a plurality of first beam splitters parallel to each other;
a second waveguide sheet comprising a second waveguide structure and a second out-coupling structure that are sequentially arranged along the first direction, wherein the second waveguide structure comprises a second turning mirror and a second turning structure that are sequentially arranged along a third direction, wherein the second turning structure comprises a plurality of second beam splitters parallel to each other,
wherein the second waveguide sheet and the first waveguide sheet are parallel to each other and are stacked, the first turning mirror and the second turning mirror are arranged correspondingly, the first waveguide structure is mirror-symmetrical to the second waveguide structure, and a turning reflection slope of the first turning mirror is parallel to the plurality of first beam splitters; a turning reflection slope of the second turning mirror is parallel to the plurality of second beam splitters; the second direction is parallel to the third direction and opposite to the third direction, and the first direction is perpendicular to at least one of the second direction or the third direction;
a cementing layer disposed between the first waveguide sheet and the second waveguide sheet; and
a geometric in-coupling prism disposed in a middle region between the first turning structure and the second turning structure, wherein a projected surface of the geometric in-coupling prism facing the second direction is a quadrilateral, wherein the quadrilateral comprises a light incident edge and a light emission edge that are opposite to each other, and a first side edge and a second side edge that are opposite to each other, wherein the light incident edge and the first side edge form an acute angle θ, the acute angle θ=60° to 80°, and the first side edge is perpendicular to the light emission edge.

2. The symmetrical pupil expansion apparatus of claim 1, wherein a thickness of the first waveguide sheet is the same as or different from a thickness of the second waveguide sheet.

3. The symmetrical pupil expansion apparatus of claim 1, wherein the second side edge and the light incident edge form a first included angle, the second side edge and the light emission edge form a second included angle, and the first included angle is the same as or different from the second included angle.

4. The symmetrical pupil expansion apparatus of claim 1, wherein
the plurality of first beam splitters are arranged equidistantly and form an inclination angle α with the second direction, wherein the inclination angle α=40° to 50°; the plurality of second beam splitters are arranged equidistantly and form an inclination angle β with the third direction, wherein the inclination angle α and the inclination angle β have a same degree and opposite directions.

5. The symmetrical pupil expansion apparatus of claim 4, wherein
the first out-coupling structure comprises a plurality of third beam splitters arranged equidistantly along the first direction, and the second out-coupling structure comprises a plurality of fourth beam splitters arranged equidistantly along the first direction, wherein the first out-coupling structure and the second out-coupling structure are arranged correspondingly, and a number of the plurality of third beam splitters is the same as a number of the plurality of fourth beam splitters.

6. The symmetrical pupil expansion apparatus of claim 5, wherein
the geometric in-coupling prism is a quadrangular prism, and the first turning mirror and the second turning mirror are triangular prisms or quadrangular prisms.

7. The symmetrical pupil expansion apparatus of claim 6, wherein the first waveguide structure further comprises a first compensation plate, and the second waveguide structure further comprises a second compensation plate; the first compensation plate and the second turning structure are arranged correspondingly, and the second compensation plate and the first turning structure are arranged correspondingly.

8. The symmetrical pupil expansion apparatus of claim 1, wherein
the cementing layer is disposed between the first waveguide sheet and the second waveguide sheet, and the following first formula is satisfied:
$$sin ( 2 ω - \frac{μ}{2} ) \geq \frac{{n}_{G}}{{n}_{W}}$$
wherein the plurality of third beam splitters and the plurality of fourth beam splitters each form an angle ω with the first direction; 0°≤μ≤40°; a refractive index of the first waveguide sheet and a refractive index of the second waveguide sheet are n_{W}; a refractive index of the cementing layer is n_{G}; a thickness of the cementing layer is from 0.5 μm to 5 μm.

9. The symmetrical pupil expansion apparatus of claim 1, wherein
the cementing layer is disposed between the first waveguide sheet and the second waveguide sheet, a magnesium fluoride coating is provided between the first waveguide sheet and the cementing layer, and between the second waveguide sheet and the cementing layer, and the following second formula is satisfied:
$$sin ( 2 ω - \frac{μ}{2} ) \geq \frac{{n}_{C}}{{n}_{W}}$$
wherein the plurality of third beam splitters and the plurality of fourth beam splitters each form an angle ω with the first direction; 0°≤μ≤40°; a refractive index of the first waveguide sheet and a refractive index of the second waveguide sheet are each n_{W}; a refractive index of the magnesium fluoride coating is n_{C}; a thickness of the cementing layer is from 0.5 μm to 5 μm; a thickness of the magnesium fluoride coating is from 80 nm to 500 nm.

10. A near-eye display device, comprising the symmetrical pupil expansion apparatus of claim 1.
